(19) United States
(12) Patent Application Publication
(10) Pub. No.: US 2021/0294986 A1
(43) Pub. Date: Sep. 23, 2021

(54) COMPUTER SYSTEM, SCREEN SHARING METHOD, AND PROGRAM

(71) Applicant: OPTIM CORPORATION, Saga (JP)

(72) Inventor: Shunji SUGAYA, Tokyo (JP)

(21) Appl. No.: 17/264,618

(22) PCT Filed: Jul. 31, 2018
(86) PCT No.: PCT/JP2018/028748

§ 371 Date: Jan. 29, 2021

(51) Int. Cl. G06F 40/42; G06F 3/14

(52) U.S. Cl. CPC G06F 40/42; G06F 3/1454

(57) ABSTRACT

Provided are a computer system, a method, and a program for sharing a screen that more easily deliver instruction appropriately. The computer system that shares a screen and receives instruction remotely extracts a language used by an instructed person from a database previously registered, acquires a text or voice message from an instructing person, generates translation data by translating the acquired message into the extracted language, and outputs the generated translation data in text or voice to the instructed person.

### CROSS-REFERENCE TO RELATED APPLICATIONS

This patent application is a national phase under 35 U.S.C. § 371 of International Patent Application No. PCT/JP2018/028748 filed Jul. 31, 2018, which is hereby incorporated herein by reference in its entirety for all purposes.

### TECHNICAL FIELD

The present disclosure relates to a computer system, a method, and a program for sharing a screen that share a screen and receives instruction remotely.

### BACKGROUND

Recently, mobile terminals such as wearable terminals and terminal devices have been used to variously instruct site workers on work sites, construction sites, etc., remotely. In such an instruction, for example, a site worker takes the image of a work object with an imaging device such as a camera, and an instructing person instructs the site worker, sharing the image between an instructing terminal carried by the instructing person and an instructed terminal carried by the site worker.

However, as the numbers of global environments and foreign workers have increased in recent years, instructing persons and instructed persons use different languages more often in such remote instruction. In such a situation, a composition in which an instructing person appropriately instructs an instructed person, which translates the language used by the instructing person and displays the translated instruction on the instructed terminal (refer to Patent Document 1).

### DOCUMENT IN THE EXISTING ART

### Patent Document

Patent Document 1: JP 2009-289197 A

### SUMMARY

However, in the composition of Patent Document 1, the instruction might not be able to be delivered appropriately because the translated language might not be necessarily appropriate for the instructed person.

An objective of the present disclosure is to provide a computer system, a method, and a program for sharing a screen that more easily deliver instruction appropriately.

The present disclosure provides a computer system that shares a screen and receives instruction remotely, including:

an extraction unit that extracts a language used by an instructed person from a database previously registered;

an acquisition unit that acquires a text or voice message from an instructing person;

a memory unit that associates and stores a predetermined keyword with a plurality of words;

an alternative message output unit that supplements the message including a keyword with a word associated and stored with the keyword and supplements the message not including a keyword with a general word, and outputs an alternative message that is used in the similar sense to the supplemented message and easily translated into the language used by the instructed person, if the message is not translated appropriately;

a selection receiving unit that receives a selection for the alternative message from the instructing person;

a generation unit that generates translation data by translating the acquired message into the extracted language if the message is translated appropriately and by translating the received alternative message into the extracted language if the message is not translated appropriately; and

a translation data output unit that outputs the generated translation data in text or voice to the instructed person.

According to the present disclosure, the computer system that shares a screen and receives instruction remotely extracts a language used by an instructed person from a database previously registered; acquires a text or voice message from an instructing person; associates and stores a predetermined keyword with a plurality of words; supplements the message including a keyword with a word associated and stored with the keyword and supplements the message not including a keyword with a general word and outputs an alternative message that is used in the similar sense to the supplemented message and easily translated into the language used by the instructed person, if the message is not translated appropriately; receives a selection for the alternative message from the instructing person; generates translation data by translating the acquired message into the extracted language if the message is translated appropriately and by translating the received alternative message into the extracted language if the message is not translated appropriately; and outputs the generated translation data in text or voice to the instructed person.

The present disclosure is the category of a computer system, but the categories of a method, a program, etc. have similar functions and effects.

The present disclosure can provide a computer system, a method, and a program for sharing a screen that more easily deliver instruction appropriately.

### BRIEF DESCRIPTION OF THE DRAWINGS

FIG. 1 is a schematic diagram of the system for sharing a screen 1.

FIG. 2 is the overall schematic diagram of a screen sharing system 1.

FIG. 3 is a flow chart showing the message output process performed by the instructing terminal 100 and the instructed terminal 200.

FIG. 4 is a flow chart showing the alternative message output process performed by the instructing terminal 100 and the instructed terminal 200.

FIG. 5 shows an example of the language database.

FIG. 6 schematically shows an example where the instructing terminal 100 and the instructed terminal 200 output a message.

FIG. 7 shows examples of the alternative messages output from the instructing terminal 100.

FIG. 8 schematically shows an example where the instructing terminal 100 and the instructed terminal 200 output a message.

### DETAILED DESCRIPTION

Embodiments of the present disclosure will be described below with reference to the attached drawings. However, these are illustrative only, and the technological scope of the present disclosure is not limited thereto.

### Outline of System for Sharing a Screen 1

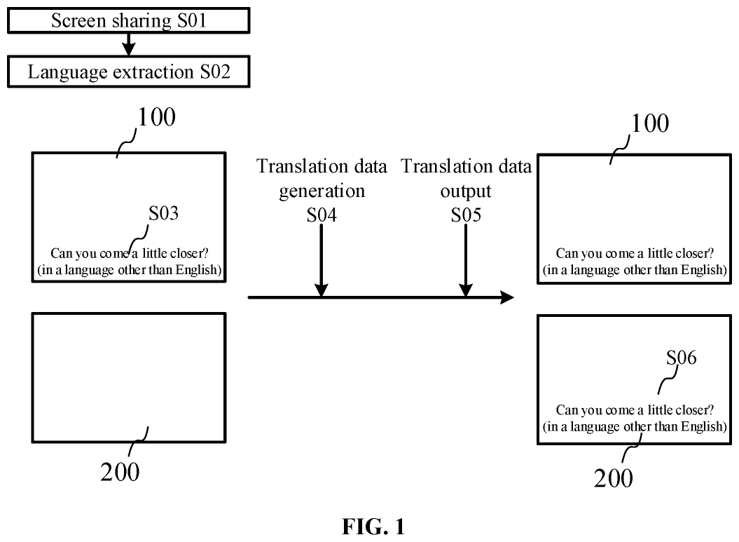

A preferable embodiment of the present disclosure is described below with reference to FIG. 1. FIG. 1 shows an overview of the system for sharing a screen 1 according to a preferred embodiment of the present disclosure. The system for sharing a screen 1 is a computer system including an instructing terminal 100 and an instructed terminal 200, which shares a screen and receives instruction remotely.

The system for sharing a screen 1 may include other devices and terminals such as computers in addition to the instructing terminal 100 and the instructed terminal 200.

The instructing terminal 100 is data-communicatively connected with the instructed terminal 200 through a public line network, etc. The instructing terminal 100 and the instructed terminal 200 share a screen to display sharing objects such as images and objects that are displayed in the sharing area set in each other of the terminals.

The instructing terminal 100 is carried by an instructing person who delivers work instruction to an instructed person such as a site worker remotely. The instructing terminal 100 previously stores a language database that associates an instructed person with a language used by the instructed person. The instructing terminal 100 generates the translation data by translating the work instruction (a text or voice message) delivered from the instructing person into the language used by the instructed person and outputs this translation data to the instructed terminal 200.

The instructing terminal 100 also outputs two or more alternative messages that are used in the similar sense to the instruction and easily translated into the language used by the instructed person. The instructing terminal 100 receives an input to select any one of the two or more output alternative messages, generates translation data by translating the received alternative message into the language used by the instructed person, and outputs the translation data to the instructed terminal 200.

The instructed terminal 200 acquires the translation data output from the instructing terminal 100 and outputs a message based on this translation data. The instructed terminal 200 shows the instructed person the work instruction delivered from the instructing person by outputting the message.

The overview of the process that the system for sharing a screen 1 performs is described below.

The instructing terminal 100 and the instructed terminal 200 shares a screen (Step S01). At this time, the instructing terminal 100 identifies the holder of the instructed terminal 200 that is sharing a screen as an instructed person. In this identification, for example, the identifier (e.g., name, ID) of the instructed person associated with the instructed terminal 200 is identified. The instructing terminal 100 and the instructed terminal 200 share a screen to display sharing objects such as images and objects that are displayed in the sharing area set in each other of the terminals.

The instructing terminal 100 extracts the language used by the instructed person from a language database previously registered (Step S02). The instructing terminal 100 extracts the language used by the instructed person associated with the identified identifier of the instructed person from the database.

The instructing terminal 100 acquires a text or voice message from the instructing person (Step S03). The instructing terminal 100 acquires work instruction from the instructing person as a message by receiving a text input from the input unit such as a touch panel or a keyboard or a voice input from the input unit such as a microphone.

The instructing terminal 100 generates translation data by translating the acquired message into the language used by the extracted instructed person (Step S04). The instructing terminal 100 translates the acquired message into the language used by the instructed person by translation methods such as rule translation, statistical translation, or deep neural network translation. The instructing terminal 100 generates the translated message as translation data.

The instructing terminal 100 outputs the generated translation data to the instructed terminal 200 (Step S05). The instructing terminal 100 outputs the translation data by transmitting it to the instructed terminal 200 that is sharing a screen.

The instructed terminal 200 acquires the translation data. The instructed terminal 200 outputs the message input from the instructing person that has been translated into the language used by the instructed person based on the acquired translation data (Step S06).

The instructed terminal 200 notifies the instructed person of the work instruction from the instructing person by outputting the message to the inside or the outside of the sharing area.

### System Configuration of System for Sharing a Screen 1

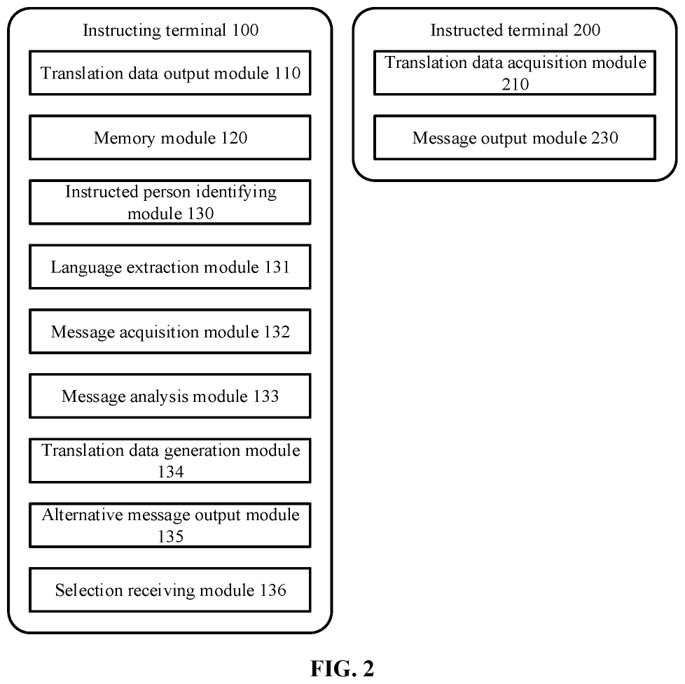

A system configuration of the system for sharing a screen 1 according to a preferable embodiment is described below with reference to FIG. 2. FIG. 2 is a block diagram illustrating a system for sharing a screen 1 according to a preferable embodiment of the present disclosure. In FIG. 2, the system for sharing a screen 1 is a computer system including an instructing terminal 100 and an instructed terminal 200, which shares a screen and receives instruction remotely. The instructing terminal 100 is data-communicatively connected with the instructed terminal 200 through a public line network (e.g. the Internet network, a third and a fourth generation networks).

The system for sharing a screen 1 may also include other devices and terminals such as computers as described above.

The instructing terminal 100 includes a control unit 11 provided with a central processing unit (hereinafter referred to as “CPU”), a random access memory (hereinafter referred to as “RAM”), and a read only memory (hereinafter referred to as “ROM”); and a communication unit such as a device that is capable to communicate with the instructed terminal 200, for example, a Wireless Fidelity or Wi-Fi® enabled device complying with IEEE 802.11. The instructing terminal 100 also includes a memory unit such as a hard disk, a semiconductor memory, a record medium, or a memory card to store data. The instructing terminal 100 also includes a processing unit provided with various devices that perform various processes.

In the instructing terminal 100, the control unit reads a predetermined program to achieve a translation data output module 110 in cooperation with the communication unit. In the instructing terminal 100, the control unit reads a predetermined program to achieve a memory module 120 in cooperation with the memory unit. In the instructing terminal 100, the control unit reads a predetermined program to achieve an instructed person identifying module 130, a language extraction module 131, a message acquisition module 132, a message analysis module 133, a translation data generation module 134, an alternative message output module 135, and a selection receiving module 136 in cooperation with the processing unit.

The instructed terminal 200 includes a control unit including a CPU, a RAM, and a ROM, a communication unit such as a device that is capable to communicate with the instructing terminal 100, and a processing unit provided with various devices that perform various processes in the same way as the instructing terminal 100.

In the instructed terminal 200, the control unit reads a predetermined program to achieve a translation data acquisition module 210 in cooperation with the communication unit. In the instructed terminal 200, the control unit reads a predetermined program to achieve a message output module 230 in cooperation with the processing unit.

### Message Output Process

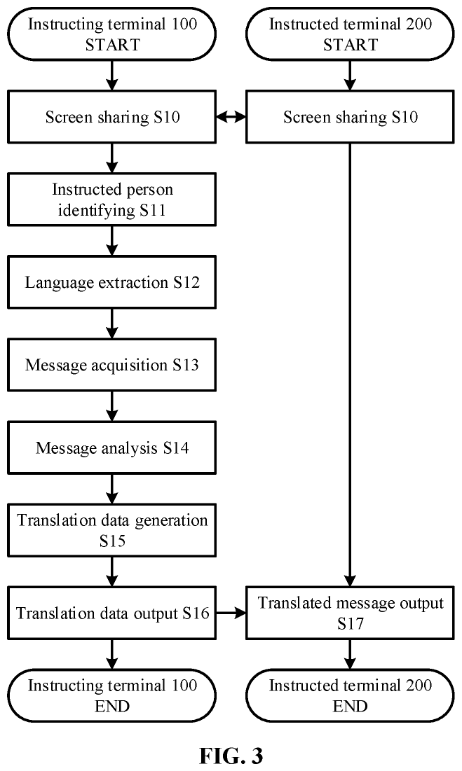

The message output process that the system for sharing a screen 1 performs is described below with reference to FIG. 3. FIG. 3 is a flow chart showing the message output process performed by the instructing terminal 100 and the instructed terminal 200. The tasks executed by the modules of each of the above-mentioned devices will be explained below together with this process.

The instructing terminal 100 and the instructed terminal 200 shares a screen (Step S10). In Step S10, the sharing areas sharing a screen that are each previously set in the instructing terminal 100 and the instructed terminal 200 display sharing objects such as images and objects that are displayed in the sharing area set in each other of the terminals.

At this time, the instructed terminal 200 takes an image of the moving or still image of a work site with the imaging device such as a camera installed in the instructed terminal 200 and displays this image on the sharing area. The instructing terminal 100 shares a screen to display the image as a sharing object. The instructing person delivers instruction remotely, viewing the image.

The screen sharing performed in Step S10 is similar to a general screen sharing. Therefore, the detail description is omitted.

The instructed person identifying module 130 identifies the instructed person (Step S11). In Step S11, the instructed person identifying module 130 identifies the instructed person based on the identifier (information that can uniquely identify an object, for example, a phone number, an IP address, a MAC address, various IDs) of the instructed terminal 200 that is sharing a screen. The instructed person identifying module 130 identifies the identifier of the instructed person previously associated with the identifier (information that can uniquely identify an object, for example, a phone number, an IP address, a MAC address, various IDs) of the instructed terminal 200. The instructed person identifying module 130 identifies the instructed person by identifying the identifier of the instructed person.

The language extraction module 131 extracts the language used by the instructed person from a language database previously registered (Step S12). In Step S12, the language extraction module 131 extracts the language used by the instructed person by looking up the language database that previously associates and registers the name, the identifier, and the language of the instructed person. At this time, the language extraction module 131 extracts the language used by the instructed person by extracting the language associated with the identified identifier of the instructed person.

### Language Database

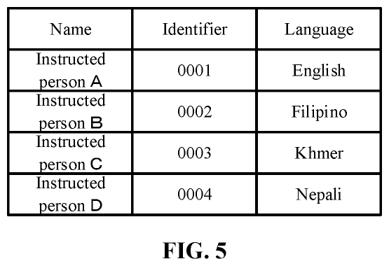

The language database is described with reference to FIG. 5. FIG. 5 shows one example of the language database stored in the memory module 120. The language database previously associates and registers the name, the identifier, and the language of an instructed person. The memory module 120 previously stores the language database. In this example, the name “Instructed person A” is associated and registered with the identifier “0001” and the language “English.” The names of other instructed persons are associated and registered with their respective identifiers and languages in the same way.

The process to extract the language of the instructed person by the language extraction module 131 in the step S12 is described below with reference to FIG. 5. In the above-mentioned process, when identifying the instructed person, the instructed person identifying module 130 identifies the identifier of the instructed person associated with the identifier of the instructed terminal 200 that is sharing a screen. In this example, the identifiers of the instructed person that the instructed person identifying module 130 identifies are “Instructed person A” and “0001”. The language extraction module 131 extracts the language associated with the identified identifiers of the instructed person by looking up the language database. At this time, the language extraction module 131 extracts the language “English” associated with “Instructed person A” and “0001” which are the identified identifiers of the instructed person. The language of the instructed person extracted at this time is used in the process described later.

The language is registered in the language database in the above-mentioned example. However, the nationality may be registered instead of the language. In this case, the nationality is associated and registered with the official language, and the official language only has to be extracted as the language used by the instructed person.

The instructing terminal 100 extracts the language used by the instructed person in this way. The use of the language database that previously associates the instructed person with a language does not need to select the translation language and enables the work efficiency to improve when the instructed person receives instruction remotely. Moreover, no translation language needs to be selected so that instruction can be more easily appropriately delivered.

The message acquisition module 132 acquires a text or voice message from the instructing person (Step S13). In Step S13, the message acquisition module 132 receives a text or voice input from the instructing person by receiving a text input from the input unit such as a touch panel or a keyboard or a voice input from the input unit such as a sound collector (e.g., microphone) from the instructing person. The message acquisition module 132 acquires the text or the voice that has been received in this way as a message.

The process of the step S13 is described based on one example. For example, the message acquisition module 132 receives an input of the text, “Can you come a little closer? (in a language other than English)” that the instructing person has input to the input unit as a message and then acquires it. Alternatively, for example, the message acquisition module 132 receives an input of the pronunciation, “Can you come a little closer? (in a language other than English)” that the instructing person has talked into the sound collector as a message and then acquires it.

If the acquired message is a text, the message acquisition module 132 may display the acquired message in any one or both of the inside and the outside of the sharing area. Alternatively, the message acquisition module 132 may not display the message in the inside or the outside of the sharing area when acquiring it but display the acquired message in any one or both of the inside and the outside of the sharing area when the process to translate the message described later is completed. If the acquired message is a voice, the message acquisition module 132 may output the acquired message from a sound device such as a speaker. Alternatively, the message acquisition module 132 may not output the message from a sound device when acquiring it but output the message from a sound device when the process to translate the message that is described later is completed. Even if the acquired message is a voice, the message acquisition module 132 may display a text resulted from text recognition in the above-mentioned way when the acquired message is a text.

The message analysis module 133 analyzes the acquired image (Step S14). In Step S14, the message analysis module 133 analyzes whether the acquired message is a text or a voice. If the message is a text, the message analysis module 133 performs the process of the step S15 described later. If the acquired message is a voice, the message analysis module 133 performs voice analysis. The message analysis module 133 recognizes the text of the acquired voice resulted from voice analysis and performs the process described later based on the recognized text.

The translation data generation module 134 generates translation data by translating the acquired message into the language used by the extracted instructed person (Step S15). In Step S15, if the acquired message is a text, the translation data generation module 134 translates it. If the acquired message is a voice, the translation data generation module 134 translates the recognized text resulted from voice analysis. The translation data generation module 134 translates the message by rule translation, statistical translation, deep neural network translation, etc. The translation data generation module 134 generates the translated result as translation data.

The translation that translation data generation module 134 performs is described below based on the above-mentioned example. The translation data generation module 134 translates the acquired message “Can you come a little closer? (in a language other than English)” into English that is the language used by the instructed person. As the result, the translation data generation module 134 generates “Can you come a little closer?” that has been translated from the message into English as translation data.

The translation data output module 110 outputs the generated translation data to the instructed terminal 200 (Step S16).

The translation data acquisition module 210 acquires the translation data output from the instructing terminal 100.

The message output module 230 outputs the translated message that has been translated from the message input from the instructing person into the language used by the instructed person based on the acquired translation data (Step S17). In Step S17, if the message that the instructing terminal 100 has acquired is a text, the message output module 230 outputs the translated text input as a message in text or voice. If the message that the instructing terminal 100 has acquired is a voice, the message output module 230 outputs the translated text recognized from the voice input as a message in text or voice.

If the message that the instructing terminal 100 has acquired is a text, the message output module 230 may display the translated message in any one or both of the inside and the outside of the sharing area. If the message that the instructing terminal 100 has acquired is a voice, the message output module 230 may output the translated message from a sound device such as a speaker. Whether the message that the instructing terminal 100 has acquired is a text or a voice, the message output module 230 may display the translated message in text in any one or both of the inside and the outside of the sharing area and output the translated message from a sound device.

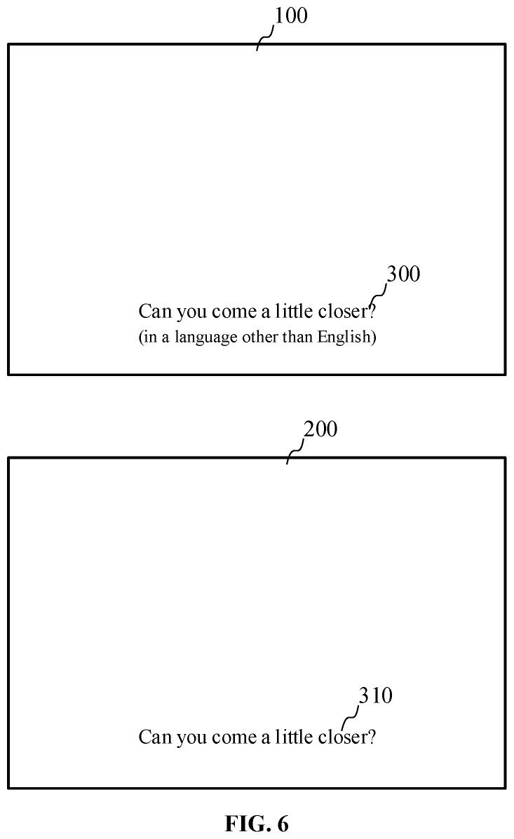

The state where the instructing terminal 100 and the instructed terminal 200 output a message is described below with reference to FIG. 6. FIG. 6 schematically shows an example where the instructing terminal 100 and the instructed terminal 200 output a message. FIG. 6 schematically shows the sharing areas of the instructing terminal 100 and the instructed terminal 200. In this example, the message that the instructing terminal 100 has acquired is a text. The example message is “Can you come a little closer? (in a language other than English)” as mentioned above. Furthermore, the instructed person is “Instructed person A,” and the language used by Instructed person A is “English” as mentioned above. The sharing objects such as images and objects are omitted from FIG. 6.

The message acquisition module 132 displays “Can you come a little closer? (in a language other than English)” that is the acquired message 300 in the sharing area. The message output module 230 displays “Can you come a little closer?” that is the translated message 310 that has been translated from the acquired message 300 into English in the sharing area. If the acquired message 300 is a voice, the message acquisition module 132 outputs the acquired message 300 in voice or text, and the message output module 230 outputs the translated message 310 that has been translated from the acquired message 300 into English in voice or text.

Whether the acquired message 300 is a text or a voice, the message acquisition module 132 may display the message 300 in the sharing area and output it in voice, and the message output module 230 may display the translated message 310 in the sharing area and outputs it in voice.

The locations to display the message 300 and the translated message 310 can be appropriately changed within the sharing area. The locations to display the message 300 and the translated message 310 are not limited within the sharing area but may be without it.

This allows the work instruction to be notified from an instructing person to an instructed person.

### Alternative Message Output Process

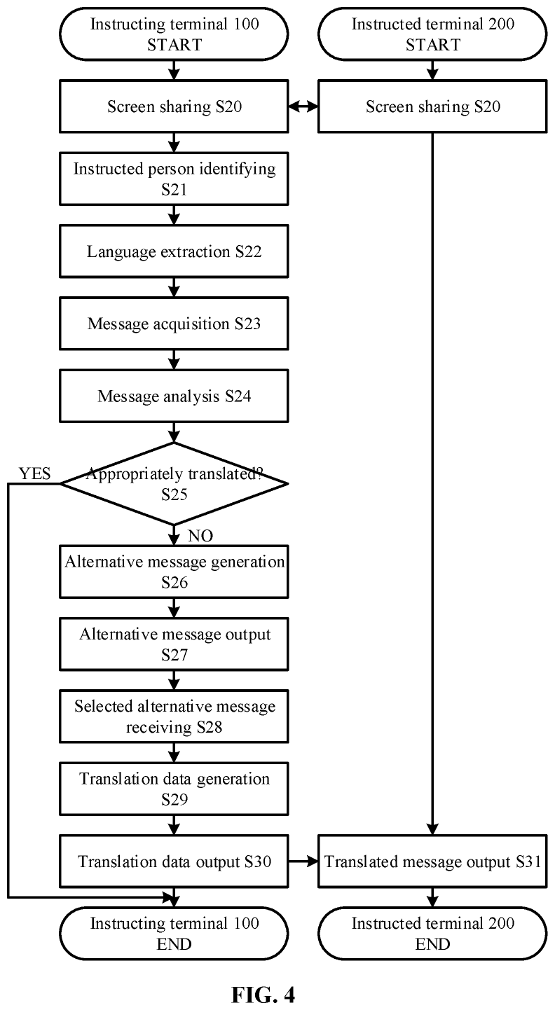

The alternative message output process that the system for sharing a screen 1 performs is described below with reference to FIG. 4. FIG. 4 is a flow chart showing the alternative message output process performed by the instructing terminal 100 and the instructed terminal 200. The tasks executed by the modules of each of the above-mentioned devices will be explained below together with this process. The detailed explanation of the tasks as same as those of the above-mentioned message output process is omitted.

The instructing terminal 100 and the instructed terminal 200 shares a screen (Step S20). The step S20 is processed in the same way as the above-mentioned step S10.

The instructed person identifying module 130 identifies the instructed person (Step S21). The step S21 is processed in the same way as the above-mentioned step S11.

The language extraction module 131 extracts the language used by the instructed person from a language database previously registered (Step S22). The step S22 is processed in the same way as the above-mentioned step S12.

The message acquisition module 132 acquires a text or voice message from the instructing person (Step S23). The step S23 is processed in the same way as the above-mentioned step S13.

The message analysis module 133 analyzes the acquired image (Step S24). The step S24 is processed in the same way as the above-mentioned step S14.

The message analysis module 133 judges if the message is translated appropriately (Step S25). In Step S25, the message analysis module 133 judges if the input text message includes an error or an omission, if the input text or voice message has more than one meaning, and if the input text or voice message is ambiguous (for example, due to the message including a dialect, an environmental sound, or a spoken language) from the result of analyzing the message. Specifically, the message analysis module 133 judges if the acquired message can be uniquely translated into a target language. Especially, this is effective if the message has more than one meaning or a dialect because the message is input orally if the message is a voice.

If the message analysis module 133 judges that the message is translated appropriately (Step S25, YES), the instructing terminal 100 and the instructed terminal 200 perform tasks after the step S15 in the above-mentioned message output process. This process is ended here to simplify the explanation.

If the message analysis module 133 judges that the message is not translated appropriately (Step S25, NO), the alternative message output module 135 generates an alternative message that is used in the similar sense to the acquired message and easily translated into the language used by the instructed person (Step S26). In Step S26, the similar sense means that the messages are similar but become different in meaning after translation. Specifically, the alternative message output module 135 generates an alternative message by supplementing the core of the acquired message with the content or the words.

The memory module 120 previously stores a word (e.g., back, clear, proceed (in a language other than English) often used on the site as a keyword and associates the keyword with two or more words (e.g., get a process going, move forward (in a language other than English)). If the message analysis module 133 judges that the acquired message includes the keyword, the alternative message output module 135 generates a text by supplementing the acquired message with the words associated with this keyword. If the message analysis module 133 judges that the acquired message does not include the keyword, the alternative message output module 135 generates a text by supplementing the acquired message with a general word.

For detailed explanation, the acquired message “Go back a little (in a language other than English)” is held up as an example. If the message analysis module 133 acquires “Go back a little (in a language other than English)” as the message, the message analysis module 133 analyzes that this message includes the keyword “back (in a language other than English)” previously stored. The alternative message output module 135 supplements the acquired message with the words “get a process going (in a language other than English) ” and “move forward (in a language other than English) ” that are associated with this keyword “back” and generates alternative messages “Could you go back a little toward the previous position? (in a language other than English)” and “Will you come back to the process a little before? (in a language other than English)” as supplemented messages.

The memory module 120 may previously store not only a word often used on the site but also the dialect of the instructing person as a keyword and then associate it with the common language. Specifically, if the message analysis module 133 judges that the acquired message includes a dialect, the alternative message output module 135 generates a text by supplementing the acquired message with the words associated with this dialect as an alternative message.

The alternative message output module 135 outputs the generated alternative messages (Step S27). In Step S27, the alternative message output module 135 outputs the acquired message and the generated alternative messages on its display unit.

The selection receiving module 136 receives a selection input of the output alternative messages from the instructing person (Step S28). In Step S28, the selection receiving module 136 receives the selection input of an alternative message suitable for the intention of the instructing person by receiving a selection operation such as a touch operation, a voice input, or a gesture input from the instructing person.

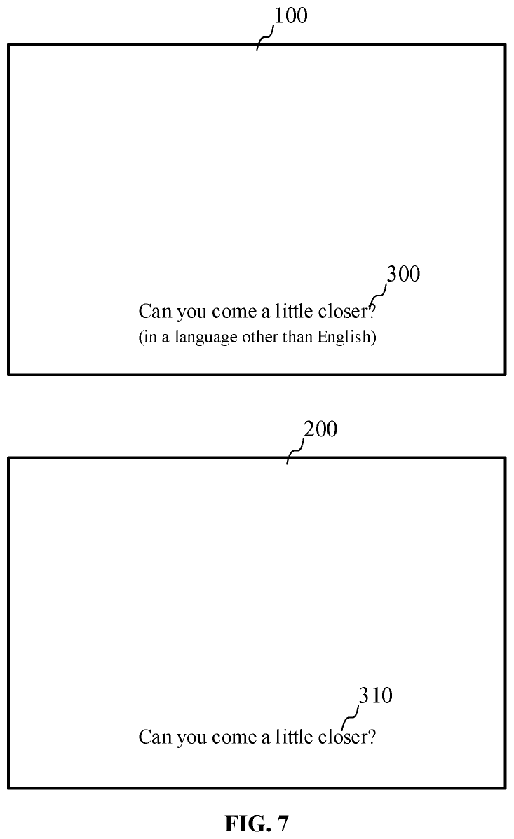

The alternative messages output from the alternative message output module 135 are described with reference to FIG. 7. FIG. 7 shows examples of the alternative messages output from the alternative message output module 135. The alternative message output module 135 outputs the acquired message 400 and the generated alternative messages 410, 420, and the explanation text 430 on the display unit. The acquired message 400 is “Go back a little (in a language other than English)” that has been acquired from the instructing person. The alternative message 410 is “A: Could you go back a little toward the previous position? (in a language other than English) ” that is one of the alternative messages after the acquired message is supplemented. The alternative message 420 is “B: Will you come back to the process a little before? (in a language other than English)” that is one of the alternative messages after the acquired message is supplemented. The explanation text 430 is “What do you mean? Please select it.” to prompt the instructing person to select an alternative message.

The instructing person can select a message near the intention by selecting either of the alternative messages 410, 420 output from the alternative message output module 135. The alternative message 420 that the selection receiving module 136 has received is highlighted. The message to be displayed in the instructing terminal 100 in the following process when the screen is being shared is the selected alternative message.

If the alternative message output from the alternative message output module 135 is different from the intention of the instructing person, the selection receiving module 136 receives an input accordingly. At this time, the alternative message output module 135 displays a notification prompting the instructing person to input a message again to acquire the message again. When the alternative message output module 135 prompts the instructing person to input a message again, the alternative message output module 135 also displays a notification prompting the instructing person to input, for example, more specific or simpler instruction as a message. The selected alternative message needs not necessarily be highlighted.

The translation data generation module 134 generates translation data by translating the selected message into the language used by the extracted instructed person (Step S29). The step S29 is processed in the same way as the above-mentioned step S15. In this process, since the selected alternative message is “Will you come back to the process a little before? (in a language other than English),” the translation data generation module 134 generates “Will you come back to the process a little before?” as translation data by translating the alternative message into English.

The translation data output module 110 outputs the generated translation data to the instructed terminal 200 (Step S30).

The translation data acquisition module 210 acquires the translation data output from the instructing terminal 100.

The message output module 230 outputs the translated message that has been translated from the alternative message input from the instructing person into the language used by the instructed person based on the acquired translation data (Step S31). In Step S31, if the message that the instructing terminal 100 has acquired is a text, the message output module 230 outputs the translated text of the alternative message based on the input message in text or voice. If the message that the instructing terminal 100 has acquired is a voice, the message output module 230 outputs the translated text of the alternative message based on the text recognized from the voice input as a message in text or voice.

If the message that the instructing terminal 100 has acquired is a text, the message output module 230 may display the translated alternative message based on the acquired message in any one or both of the inside and the outside of the sharing area. If the message that the instructing terminal 100 has acquired is a voice, the message output module 230 may output the translated alternative message based on the acquired message from a sound device such as a speaker. If the message that the instructing terminal 100 has acquired is a text or a voice, the message output module 230 may display the translated alternative message based on the acquired message in text in any one or both of the inside and the outside of the sharing area and output the translated message from a sound device.

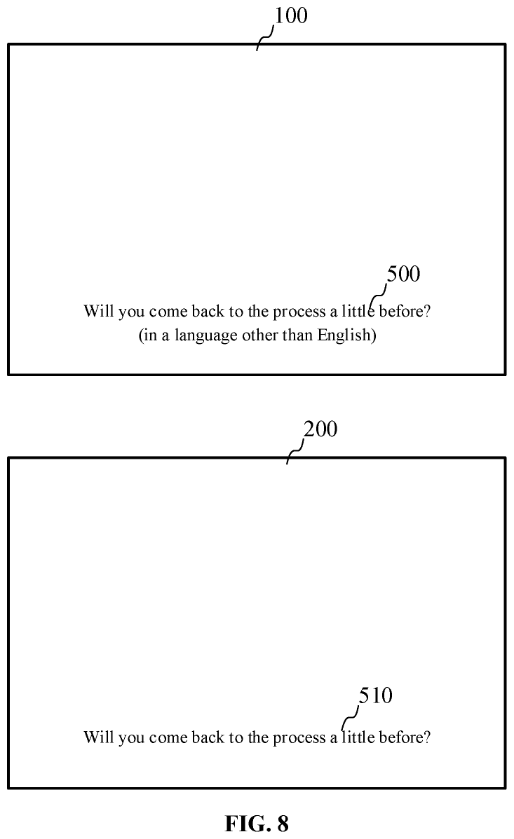

The state where the instructing terminal 100 and the instructed terminal 200 output a message is described below with reference to FIG. 8. FIG. 8 schematically shows an example where the instructing terminal 100 and the instructed terminal 200 output a message. FIG. 8 schematically shows the sharing areas of the instructing terminal 100 and the instructed terminal 200. In this example, the message that the instructing terminal 100 has acquired is a text. The example message is “Go back a little (in a language other than English” as mentioned above. Furthermore, the instructed person is “Instructed person A,” and the language used by Instructed person A is “English” as mentioned above. The sharing objects such as images and objects are omitted from FIG. 8.

The alternative message output module 135 displays “Will you come back to the process? (in a language other than English)” that is an alternative message 500 to the acquired message in the sharing area. The message output module 230 displays the translated message 510 “Will you come back to the process?” that has been translated from the alternative message 500 into English in the sharing area. If the acquired message is a voice, the message acquisition module 132 outputs the alternative message 500 to the acquired message in voice or text, and the message output module 230 outputs the translated message 510 that has been translated from the alternative message 500 to the acquired message into English in voice or text.

Whether the acquired message is a text or a voice, the message acquisition module 132 may display the alternative message 500 in the sharing area and output it in voice, and the message output module 230 may display the translated message 510 in the sharing area and outputs it in voice.

The locations to display the alternative message 500 and the translated message 510 can be appropriately changed within the sharing area. The locations to display the alternative message 500 and the translated message 510 are not limited within the sharing area but may be without it.

This allows the work instruction to be notified from an instructing person to an instructed person.

To achieve the means and the functions that are described above, a computer (including a CPU, an information processor, and various terminals) reads and executes a predetermined program. For example, the program may be provided through Software as a Service (SaaS), specifically, from a computer through a network or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present disclosure are described above. However, the present disclosure is not limited to the above-mentioned embodiments. The effect described in the embodiments of the present disclosure is only the most preferable effect produced from the present disclosure. The effects of the present disclosure are not limited to those described in the embodiments of the present disclosure.

### DESCRIPTION OF REFERENCE NUMERALS

1 System for sharing a screen

100 Instructing terminal

200 Instructed terminal

1. A computer system that shares a screen and receives instruction remotely, comprising:
an extraction unit that extracts a language used by an instructed person from a database previously registered;
an acquisition unit that acquires a text or voice message from an instructing person;
a memory unit that associates and stores a predetermined keyword with a plurality of words;
an alternative message output unit that supplements the message including a keyword with a word associated and stored with the keyword and supplements the message not including a keyword with a general word, and outputs an alternative message that is used in the similar sense to the supplemented message and easily translated into the language used by the instructed person, if the message is not translated appropriately;
a selection receiving unit that receives a selection for the alternative message from the instructing person;
a generation unit that generates translation data by translating the acquired message into the extracted language if the message is translated appropriately and by translating the received alternative message into the extracted language if the message is not translated appropriately; and
a translation data output unit that outputs the generated translation data in text or voice to the instructed person.

2. (canceled)

3. A method for sharing a screen that is performed by a computer system that shares a screen and receives instruction remotely, comprising the steps of:
extracting a language used by an instructed person from a database previously registered;
acquiring a text or voice message from an instructing person;
associating and storing a predetermined keyword with a plurality of words;
supplementing the message including a keyword with a word associated and stored with the keyword and supplementing the message not including a keyword with a general word and outputting an alternative message that is used in the similar sense to the supplemented message and easily translated into the language used by the instructed person, if the message is not translated appropriately,;
receiving a selection for the alternative message from the instructing person;
generating translation data by translating the acquired message into the extracted language if the message is translated appropriately and by translating the received alternative message into the extracted language if the message is not translated appropriately; and
outputting the generated translation data in text or voice to the instructed person,

4. A computer readable program for causing a computer system that shares a screen and receives instruction remotely to execute the steps of:
extracting a language used by an instructed person from a database previously registered;
acquiring a text or voice message from an instructing person;
associating and storing a predetermined keyword with a plurality of words;
supplementing the message including a keyword with a word associated and stored with the keyword and supplementing the message not including a keyword with a general word and outputting an alternative message that is used in the similar sense to the supplemented message and easily translated into the language used by the instructed person, if the message is not translated appropriately;
receiving a selection for the alternative message from the instructing person;
generating translation data by translating the acquired message into the extracted language if the message is translated appropriately and by translating the received alternative message into the extracted language if the message is not translated appropriately; and
outputting the generated translation data in text or voice to the instructed person.
